(19) United States
(12) Patent Application Publication
(10) Pub. No.: US 2013/0106831 A1
(43) Pub. Date: May 2, 2013

(54) 3-D PRESENTATION OF INFORMATION

(71) Applicant: Jonathan Lee, Louisville, KY (US)

(72) Inventor: Jonathan Lee, Louisville, KY (US)

(73) Assignee: CBS Interactive, Inc.

(21) Appl. No.: 13/284,817

(22) Filed: Oct. 28, 2011

(51) Int. Cl. G06T 15/00

(52) U.S. Cl. 345/419

(57) ABSTRACT

Systems and methods for displaying information, which include displaying, on a display, a representation of 3-D object(s), so that information is displayed on at least one side of the 3-D object(s). Information displayed on a first side of the 3-D object(s) is related to information displayed on a second side of the 3-D object(s). Some further embodiments include: receiving, by a processor, input related to changing an appearance of an orientation of the 3-D object(s); and displaying, on the display, a change in the appearance of an orientation of the 3-D object(s), based on the input. In some further embodiments, the change in the appearance of the orientation of the 3-D object(s) is that the 3-D object(s) appears to rotate, rotate at a different speed, rotate in a different direction, or stop rotating.

### BACKGROUND

Some internet web sites are associated with systems that provide data, including categories of related data to their users. For example, in the case of a product information web site, the web site may include product reviews, images, videos, specifications, comparisons with other products, user commentary, locations where products may be purchased, prices for products, etc. In the case of a news web site, the web site may include news articles, photographs, user commentary, URL web links to related articles, etc. In the case of a social networking web site, the web site may include photographs (such as pictures of users and their friends or relatives), personal information about users, links to web pages for friends of users, etc. In the case of a blog web site, the web site may include blog entries, categories of blog entries, links to related or suggested blogs, reader comments, etc. In the case of a sports web site, the web site may include team information, individual player information, game time information, etc.

### SUMMARY OF THE DISCLOSURE

Implementations of the systems and methods for displaying information are described herein. One implementation is a system including memory hardware storing program instructions. The system may further include one or more processors in data communication with the memory hardware that are configured to execute the program instructions. Upon execution of the program instructions, the one or more processors perform operations including providing display data representing at least one 3-D object, so that information is displayed on at least one side of the at least one 3-D object. The information displayed on a first side of the at least one 3-D object is related to information displayed on a second side of the at least one 3-D object. In some embodiments, the memory hardware is located on server(s) that transfer the program instructions to a client computing device for execution. In some embodiments, the instructions, when processed by a processing circuit, further perform: receiving, at a processor, input related to changing an appearance of an orientation of the at least one 3-D object; and displaying, on the display, a change in the appearance of an orientation of the at least one 3-D object, based on the input. In some embodiments, the change in the appearance of the orientation of the at least one 3-D object is that the at least one 3-D object appears to rotate, rotate at a different speed, rotate in a different direction, or stop rotating.

Another implementation is a method that includes displaying a representation of at least one 3-D object, so that information is displayed on at least one side of the at least one 3-D object. The information displayed on a first side of the at least one 3-D object is related to information displayed on a second side of the at least one 3-D object. In some embodiments, the method further includes: receiving, at a processor, input related to changing an appearance of an orientation of the at least one 3-D object; and displaying, on the display, a change in the appearance of an orientation of the at least one 3-D object, based on the input. In some embodiments, the change in the appearance of the orientation of the at least one 3-D object is that the at least one 3-D object appears to rotate, rotate at a different speed, rotate in a different direction, or stop rotating.

Yet another implementation is a tangible computer-readable medium having instructions encoded thereon, such that the instructions, when processed by a processing circuit, perform the display of a representation of at least one 3-D object, so that information is displayed on at least one side of the at least one 3-D object. The information displayed on a first side of the at least one 3-D object is related to information displayed on a second side of the at least one 3-D object. In some embodiments, the instructions, when processed by a processing circuit, further perform: receiving, at a processor, input related to changing an appearance of an orientation of the at least one 3-D object; and displaying, on the display, a change in the appearance of an orientation of the at least one 3-D object, based on the input. In some embodiments, the change in the appearance of the orientation of the at least one 3-D object is that the at least one 3-D object appears to rotate, rotate at a different speed, rotate in a different direction, or stop rotating.

In various implementations, the information displayed on the first side is related to information displayed on all other sides of the at least one 3-D object. According to some implementations, the information displayed on the first side is not displayed at the same time as information displayed on the second side. In some implementations, the information is related to products, news, blogs, sports, or social media. According to various implementations, the information on one or more sides of the at least one 3-D object changes dynamically. In some implementations, a video is displayed on the first side and information related to the content of the video is displayed on the second side.

In various implementations, the information on the first side and the second side has an order, such that the information displayed on the first side precedes the information on the second side in the order. In some further implementations, the type of information on the first side and the second side is different from the type of information on a third side of the at least one 3-D object.

### BRIEF DESCRIPTION OF THE DRAWINGS

FIG. 1 is a schematic diagram of a system, according to an exemplary embodiment;

FIG. 2 illustrates a computer system for implementing a method of modifying data, according to an exemplary embodiment;

FIG. 3 is an illustration of a monitor displaying a representation of a cube as displayed in an internet browser window, according to an exemplary embodiment;

FIG. 4A is a flowchart of a method according to an exemplary embodiment, such that a 3-D object appears to rotate on command and comes to a stop itself;

FIG. 4B is a flowchart of a method according to an exemplary embodiment, such that a representation of a 3-D object appears to rotate on command and continues to rotate until it is commanded to stop;

FIG. 5 is a flow diagram of changes in a representation of a cube as it appears to rotate from left to right, according to an exemplary embodiment;

FIG. 6 is a flow diagram of changes in a representation of a cube as it appears to rotate from top to bottom, according to an exemplary embodiment;

FIG. 7 is a flow diagram of changes in a representation of a cube as it appears to rotate clockwise, according to an exemplary embodiment; and

FIG. 8 is a flow diagram of changes in a representation of a cube as it appears to rotate from top-left to bottom-right, according to an exemplary embodiment.

### DETAILED DESCRIPTION OF EXEMPLARY EMBODIMENTS

One or more embodiments described herein may provide a way of displaying information. A server may transfer a file containing computer-executable code to a client device.

This code may contain instructions to display a representation of a 3-D graphic or object, which includes data on one or more sides (planes, portions, faces) of the 3-D object. For example, a client computer may download a web page containing HTML and/or JavaScript from a web server and execute it in a World Wide Web browser, displaying a 3-D object. The code may contain further instructions to adjust or change the apparent position or orientation of the 3-D object relative to the viewer, according to input received. For example, the 3-D object may be made to appear to rotate according to keyboard, mouse, trackball, touchpad, touchscreen, or motion sensor input.

Rotating the 3-D object may bring different data into view that was not previously visible. Thus, a user is allowed to explore the data in an interesting visual manner. Additionally, it allows for faster access to data. It is no longer necessary for the user to click through to another web page and wait for the information to download. The information is already available and can be viewed by rotating the 3-D object instead. The methods and systems related to various embodiments are discussed in further detail below.

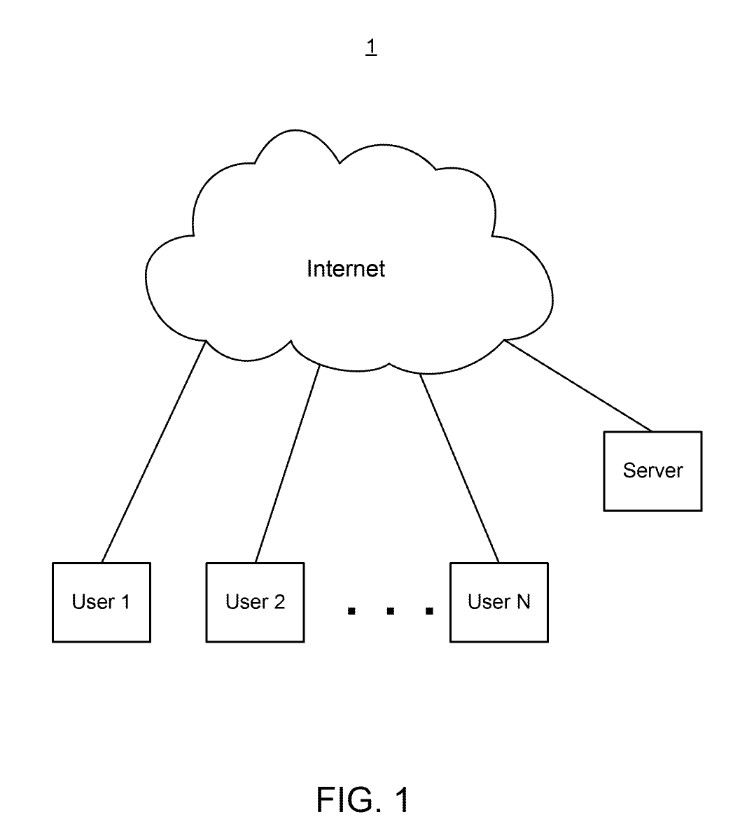

FIG. 1 illustrates a system according to some embodiments of the present invention. As shown in FIG. 1, an exemplary networked system 1 for implementing process(es) according to embodiments of the present invention may include, but is not limited to, a general-purpose computing device that interacts with users through a communications network, such as, but not limited to, the Internet. The computing device may be a server that communicates over a network with user devices, which include, but are not limited to, general-purpose computers, game consoles, smartphones, PDAs, and the like. User devices may communicate with a server through a web site. The user devices may be mobile devices and the web site may be a mobile web site, intended to be accessed through mobile devices. The user devices may communicate with a server or with each other through one or more application s comprising computer-executable instructions.

Although the exemplary system 1 of FIG. 1 involves communication through the Internet, other embodiments may include one or more servers interacting with users through any type of network. Other embodiments may involve peer-to-peer communication between user devices rather than between user devices and a server. Alternate embodiments may not involve a network at all, and may instead be implemented on a standalone device used by the user(s).

The server may be implemented as a network of computer processors. In some implementations, the server may be multiple servers, mainframe computers, networked computers, a processor-based device, and similar types of systems and devices.

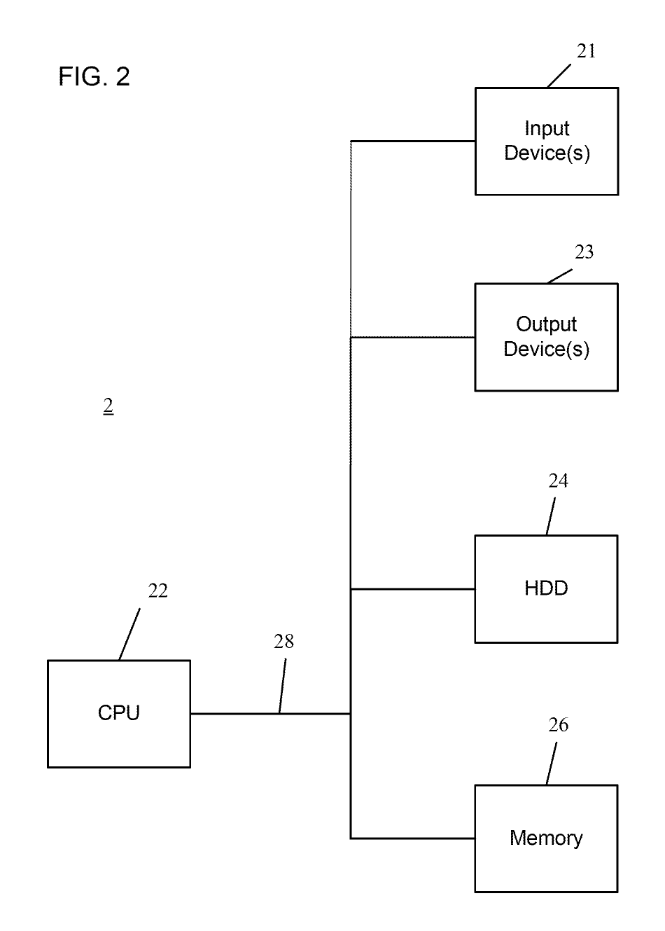

FIG. 2 illustrates a system according to some embodiments of the present invention. As shown in FIG. 2, an exemplary system 2 for implementing the method(s) discussed include (but is not limited to) a general-purpose computing device in the form of a conventional computer, including a processing unit 22 or processor, a system memory 26, and a system bus 28 that couples various system components including the system memory 26 to the processing unit 22. The system may also include input device(s) 21 and/or output device(s) 23. The system memory 26 may include one or more suitable memory devices such as, but not limited to, RAM. The computer may include a storage medium 24, such as, but not limited to, a solid state storage device and/or a magnetic hard disk drive (HDD) for reading from and writing to a magnetic hard disk, a magnetic disk drive for reading from or writing to a removable magnetic disk, and an optical disk drive for reading from or writing to removable optical disk such as a CD-RW or other optical media, flash memory, etc. The drives and their associated computer-readable media may provide non-transient, non-volatile storage of computer -executable instructions, data structures, program modules, and other data for the computer to function in the manner described herein. Various embodiments employing software and/or Web implementations are accomplished with standard programming techniques.

The processor 22 may receive input from one or more input devices 21. An input device 21 may receive input from one or more users or computing devices, and may include (but is not limited to) a keyboard, a pointing device, e.g., a mouse, trackball, or trackpad, a device that senses visual, auditory, or tactile signals (such as a touchscreen), or a device that senses motion. An input device may be part of a computing device (as in the case of a laptop, tablet computer, PDA, smartphone, or the like), or it may be external to a computing device (as in the case of an external keyboard, mouse, or motion sensor).

The processor 22 may provide output to one or more output devices 23. An output device 23 may provide output to one or more users or computing devices, and may include (but is not limited to) a display such as a CRT (cathode ray tube), LCD (liquid crystal display), plasma, OLED (organic light emitting diode),TFT (thin-film transistor), or other flexible configuration, or any other monitor or display for displaying information to the user. An output device may be part of a computing device (as in the case of a laptop, tablet computer, PDA, smartphone, or the like), or it may be external to a computing device (as in the case of an external monitor or television). In addition, an output device 23 may be any device capable of displaying a web page or outputting information that can be used for the display of a web page. Devices that output information that can be used for the display of a web page include, but are not limited to, networking devices. For example, servers 2 may distribute files (such as those containing HTML) to client computing machines 2 through networking devices 23.

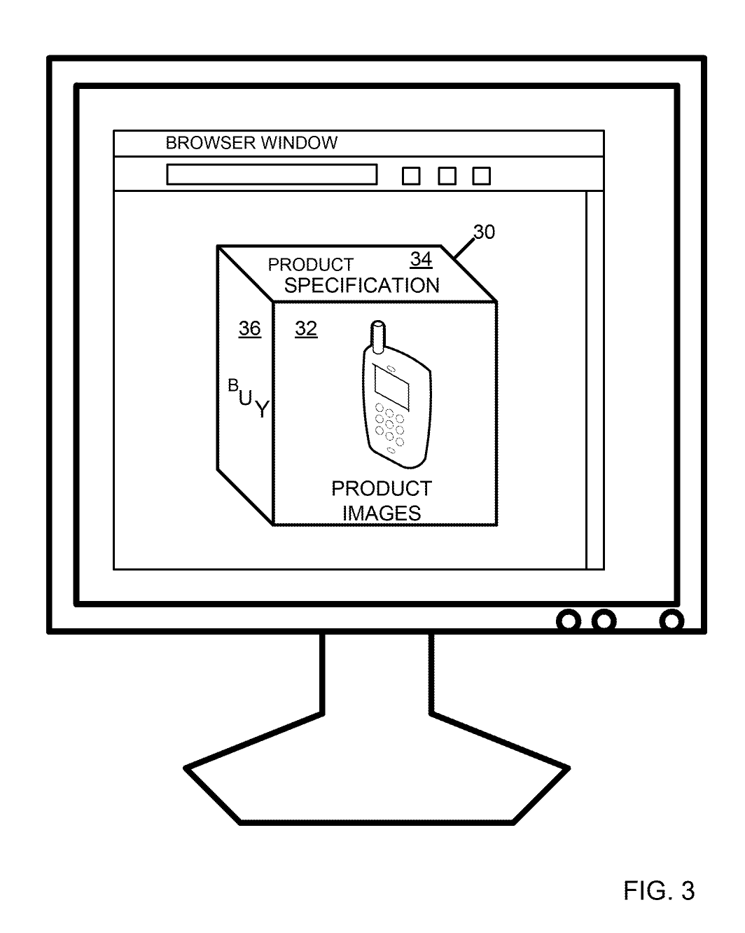

According to various embodiments, computer-executable instructions may encode a process of displaying a 3-D object. A server may transfer these instructions to a user computing device for execution. The instructions may be executable as a standalone, computer-executable program, by a web browser application (browser), or the like. When executed, the instructions may instruct the computing device to display one or more 3-D objects on a display. This is illustrated by FIG. 3, which shows a computer monitor displaying a 3-D object 30 in an internet browser window, according to an embodiment of the invention. A 3-D object 30 may be displayed in two dimensions, but in a manner such that it appears to be three-dimensional. 3-D as used herein is not limited to systems using stereoscopic methods or otherwise attempting to give the illusion of depth.

A 3-D object 30 may represent any three-dimensional form or polyhedron. Examples include, but are not limited to, a cube, rectangle, cylinder, sphere, triangular pyramid, rectangular pyramid, cone, prism, or the like. A 3-D object 30 may appear to transform from one form into another form. For example, a cube may transform into a sphere. The apparent transformation may occur at any time, at a predetermined time, or in response to input from the user. Alternatively, the 3-D object 30 may remain in the same form.

Data may be displayed on one or more sides of a 3-D object 30. The term “side” includes a plane, face, portion, or the like of a 3-D object 30. For example, data may be displayed on one or more of the six sides of a cube. As another example, groups of data may be displayed side-by-side on portions of a sphere or cylinder, rather than on different planes of the sphere or cylinder.

The data on the different sides of a 3-D object 30 may or may not be related to data on another side or all sides of the same 3-D object 30. For example, as illustrated in FIG. 3, a 3-D object 30 may be used to display information about a particular product. One side 32 of the 3-D object 30 may display one or more images of the product. Another side 34 may display information related to the product's specification. Another side 36 may display one or more options to purchase the product. Other sides may include, for example, reviews about the product, videos including the product, comparisons with other products, user commentary regarding the product, prices for the product, or the like. For instance, one side of a 3-D object 30 may include the cover art of a DVD, while another side may include a viewable video clip from the DVD, while another side may include excerpts from professional reviews of the DVD, or the like. In the case of music, one side of a 3-D object 30 may include the cover art of a music album, while another side may include a viewable music video of a song from the album, or the like.

As another example, in the case of a news web site, one or more sides of a 3-D object 30 may include news articles, photographs, user commentary, URL web links to related articles, or the like. In the case of a social networking web site, one or more sides of a 3-D object 30 may include photographs (such as pictures of users and their friends or relatives); personal information about users; links to web pages for friends of users; information or links regarding recommendations from friends or recommendations based on the user's profile or history, or the user's friends' profile(s) or history; or the like. As yet another example, in the case of a blog, one or more sides of a 3-D object 30 may include blog entries, a list of categories of blog entries, links to related or suggested blogs, reader continents, or the like. In still another example, in the case of a sports web site, one or more sides of a 3-D object 30 may include team information, player information, dates and times of games, or the like.

The data on one or more sides of a 3-D object 30 may update dynamically. The update may occur at any time, at a predetermined time, or in response to input from the user. For example, if the user selects input indicating that the 3-D object 30 should rotate, then this may cause one or more sides to be updated or change from what was previously displayed on it. Information may be streamed, dynamically, from a remote or local database(s) or server(s) for display on the 3-D object 30. Additionally, choices that the user makes may affect the type or content of the information selected for display to the user.

The data on a side of a 3-D object 30 that appears to somewhat face away from the user (such as sides 32, 36 in FIG. 3) may be displayed as a perspective representation. That is, something on the portion of the 3-D object 30 that is apparently the furthest away from the user may be smaller than the same thing, but on a portion of the 3-D object 30 that is apparently closer to the user. The perspective representation may be from a one-point perspective, two-point perspective, three-point perspective, four-point perspective, zero-point perspective, linear perspective, or any perspective. Data on a side of a 3-D object 30 that appears to face the user (such as side 32 in FIG. 3) may be displayed normally, without appearing smaller.

Data on a side of a 3-D object 30 that faces partially away from the user may not be displayed at all, or it may be displayed transparently or in a different manner than if it had been on a side that appears to face the user. Data on a side opposite from a side facing the user may not be displayed at all, displayed transparently and/or inversely, displayed in a different manner than if it had been on a side facing the user, or the like. Alternatively, data that is displayed on a side that is in perspective view may be replaced with a representative icon, representative text, or another shortened form of the data instead of being displayed in perspective.

Data that is displayed on a side of a 3-D object 30 in one orientation may be displayed in the same or a different orientation after the 3-D object 30 is rotated. For example, a 3-D object 30 may rotate and then stop rotating, so that the data would no longer be right-side-up had the data been in a fixed position on an actual rotating 3-D object. In that case, the data may be displayed right-side-up, for easy viewing by the user. Alternatively, the data may be displayed in the rotated position, or in any position.

Data that is displayed in one apparent position on a 3-D object 30 may not be in the same position after or during rotation. A particular side of a 3-D object 30 may be displayed as including particular data, and then when the 3-D object 30 is rotated 360 degrees, it may show different data unrelated to the original data, or different data related to the original data. For example, regarding FIG. 3, the product image(s) shown on side 32 may no longer be shown on side 32 after a 360-degree rotation of the cube 30. Side 32 may instead show product reviews. Alternatively, side 32 may instead show a different product image than was previously displayed.

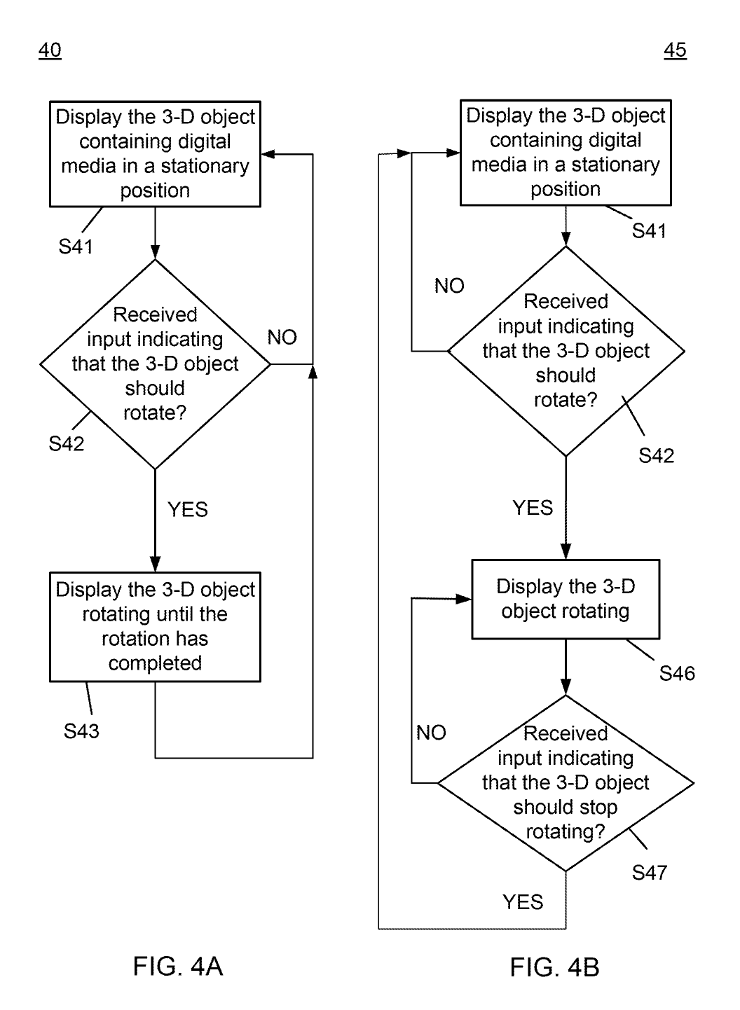

With reference to FIGS. 4A and 4B, a method of displaying data according to various embodiments is implemented by the computer system 2 according to a process 40 as shown in FIG. 4A, or a process 45 as shown in FIG. 4B. A processor 22 may execute instructions that instruct at least one output device 23 to display a 3-D object 30. In various embodiments, the 3-D object 30 is displayed on a display 23 in a manner according to the processes 40 or 45.

Referring to process 40 of FIG. 4A, in step S41, a 3-D object 30 may be displayed in a stationary position, so that it can be easily viewed or read by a user. In other embodiments, the 3-D object 30 is not displayed in a stationary position, but instead, part or all of the 3-D object 30 moves in a particular direction, in a random direction, in one direction followed by another direction(s), or the like.

In step S42, a processor 22 determines whether input has been received from an input device or devices 21 that indicates whether a 3-D object 30 should rotate (or turn, shift, change orientation, or the like). The processor 22 may accept input from a user, device, software, or the like. Input from a user or device may include input from a mouse used to hover over, click on, drag, etc. a 3-D object 30 or other object with a mouse pointer, to indicate that the 3-D object 30 should rotate or move, or to indicate the direction of rotation or movement. Input from a user or device may instead be from a keyboard, such as from the pressing of one or more keys. Input from a user or device may be a result from the touching or dragging of fingers on a touchscreen device. Input from a user or device may be a result from a verbal command, a visual command (such as, but not limited to, from a light sensor, including an infrared sensor receiving a signal from a device such as a remote). Input from a user or device may be a result from a motion sensor that has sensed motion (e.g., the motion of one or more users). Alternatively, the lack of input may itself indicate that the 3-D object 30 should rotate or move, or perform some other action(s) or cease one or more actions. Acceptable input may include one or a combination of the above types of input, or any other type of input that could indicate that rotation has been selected. If input indicates that the 3-D object should rotate, then step S43 is executed. Otherwise, step S41 is executed.

In step S43, a processor 22 may execute instructions that instruct at least one output device 23 to display a 3-D object 30 so that it appears to rotate. The data on the sides of the 3-D object 30 may be displayed on the sides during this step, or it may not be displayed until the rotation is complete. Once the rotation is complete, step S31 is executed. Rotation is complete when the 3-D object 30 has appeared to rotate by an amount (or into a position or orientation) as indicated by the input that was received in step S32.

Referring to process 45 of FIG. 4B, step S41 is the same as in process 40 of FIG. 4A. In process 45, step S42 is the same as in process 40, except that if input is received indicating that the 3-D object 30 should rotate, then for process 45, step S46 is executed. In process 45, step S46 is the same as S43 of process 40, except that in step S46, rotation of the 3-D object 30 does not complete until input is received indicating that it should stop rotating, which is determined by the processor 22 in step S47. Input indicating that rotation should stop may be any one or combination of possible inputs listed above in regard to step S42. In step S47, if such input has been received, then rotation may stop in step S41. Alternatively, rotation may slow, change (for example, change direction), or the like in response to input. If input indicating that rotation should stop (or slow, change, or the like), then rotation continues in step S46.

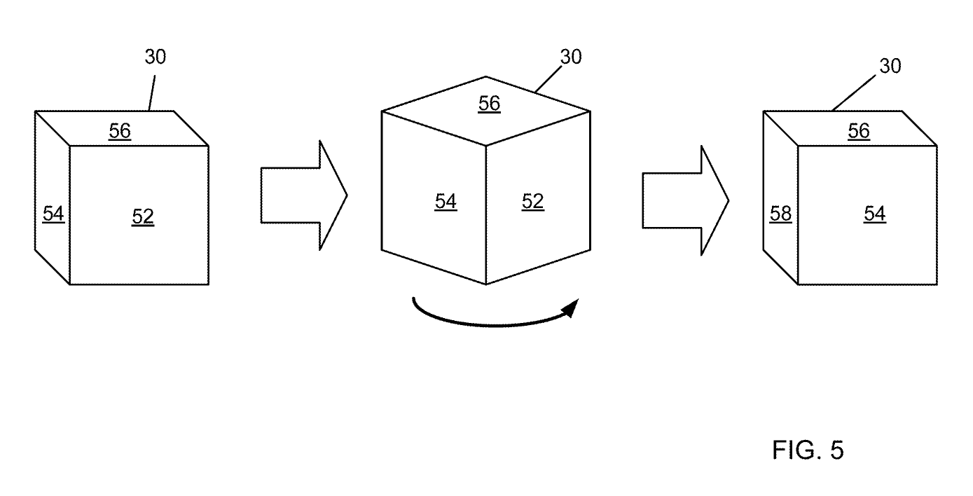

FIGS. 5-8 illustrate examples of how a 3-D object 30 may appear to rotate on a display, according to an embodiment. 3-D objects 30 may appear to rotate from left-to-right, right-to-left, top-to-bottom, bottom-to-top, clockwise, counter-clockwise, top-left to bottom-right, top-right to bottom-left, bottom-right to top-left, bottom-left to top-right, or in any manner or direction. Multiple 3-D objects 30 may be displayed, and they may all rotate in the same direction, different direction(s), or some in the same direction while one or more others rotate in different direction(s). Alternatively, some displayed 3-D objects 30 may be rotating while others do not, they may all be rotating, or they may all not be rotating.

3-D objects 30 may rotate so that a side that appears to face the user moves to a perspective view, allowing an adjacent side to face the user. 3-D objects 30 may rotate so that a side that is not in view of the user moves to a perspective view or faces the user. 3-D objects 30 may rotate 90 degrees around, 180 degrees around, 270 degrees around, continuously around, or by any number of degrees around. 3-D objects 30 may appear to “roll” haphazardly or in a pattern rather than “rotate” so that multiple or all sides become visible.

The 3-D object 30 (in this case, a cube) in FIG. 5 appears to rotate from left-to-right on the display. That is, the 3-D object 30 may be drawn on the display so that the sides 52, 54, 56 of the 3-D object 30 appear to meet each other as they may have, had it been an actual 3-D object instead of a representation of a 3-D object. In the initial position of the cube 30 in FIG. 5, side 52 faces the user (that is, it appears to face the user), sides 54, 56 face partially away from the user and are thus viewed in perspective, and side 58 faces away from the user and thus is out of view. When the cube 30 begins to appear to rotate to the right, the side 52 appears to move out of the view of the user, while side 54 appears to move closer and closer to facing the user directly. The cube 30 may stop rotating when side 54 faces the user directly. In that position, side 56 is still in view (as before), and now previously-hidden side 58 is in view, while side 52 is no longer in view.

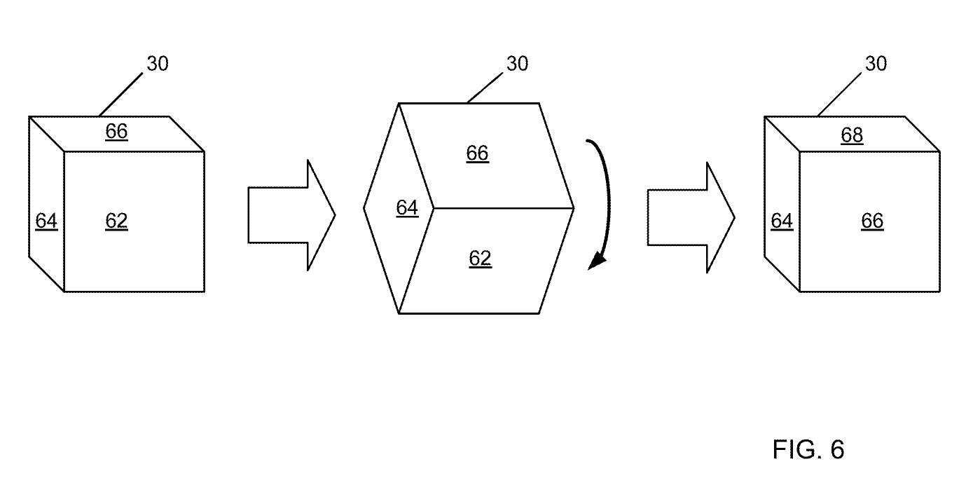

The cube 30 of FIG. 6 appears to rotate in a similar manner, except it appears to rotate from top-to-bottom on the display. In the initial position of the cube 30 in FIG. 6, side 62 faces the user, sides 64, 66 face partially away from the user and are thus viewed in perspective, and side 68 faces away from the user and thus is out of view. When the cube 30 begins to appear to rotate downward, the side 62 appears to move out of the view of the user, while side 66 appears to move closer and closer to facing the user directly. The cube 30 may stop rotating when side 66 faces the user directly. In that position, side 64 is still in view (as before), and now previously-hidden side 68 is in view, while side 62 is no longer in view.

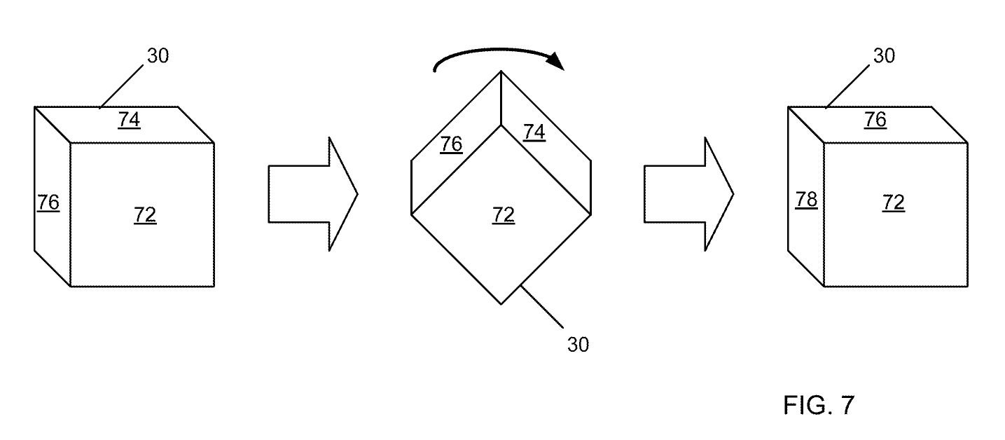

In FIG. 7, the cube 30 appears to rotate clockwise on the display. In the initial position of the cube 30 in FIG. 7, side 72 faces the user, sides 74, 76 face partially away from the user and are thus viewed in perspective, and side 78 faces away from the user and thus is out of view. When the cube 30 begins to appear to rotate clockwise, the side 74 appears to move out of the view of the user, while side 72 continues to face the user directly. The cube 30 may stop rotating when side 74 is no longer in view and side 78 is in view. In that position, side 72 is still in view (as before), side 76 is at the apparent top of the cube 30, and now previously-hidden side 78 is in view, while side 74 is no longer in view.

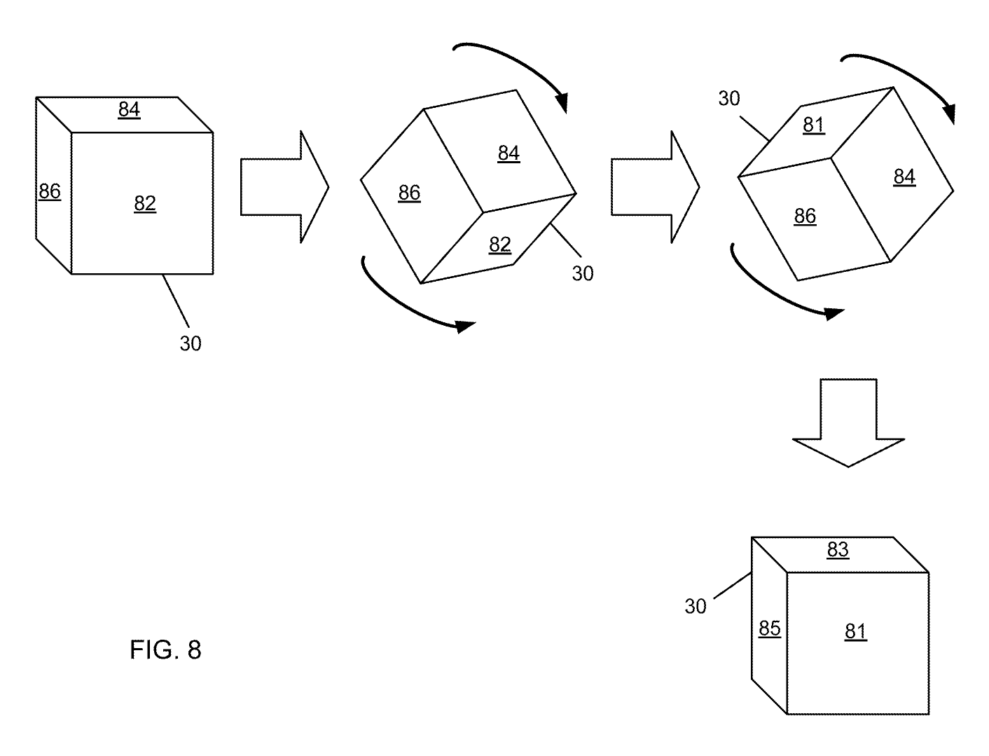

In FIG. 8, the cube 30 appears to rotate or “roll” from top-left to bottom-right on the display. In the initial position of the cube 30 in FIG. 8, side 82 faces the user, sides 84, 86 face partially away from the user and are thus viewed in perspective, and sides 81, 83, 85 face away from the user and thus are out of view. When the cube 30 begins to appear to rotate or roll, the side 82 appears to move out of the view of the user, while sides 84, 86 appear to come more into view. The cube 30 may stop rotating when the side that appears to be opposite side 82 appears to face the user, so that it appears that the cube has rotated 180 degrees. In that position, sides 82, 84, 86 are no longer in view, size 81 now appears to face the user, and sides 83, 85 appear in perspective view.

Information related to a video's content, characters, advertising, vendors, or the like may be displayed on one or more sides of a 3-D object 30. As an example, with reference to FIG. 6, a video may be playing on front-facing side 62. The user may wish to have more information about something shown in the video (for instance, but not limited to, a hotel shown in the video, characters in the video, and the like). The user may then rotate the cube 30 from top-to-bottom so that side 66 faces the user. Side 66 may include information regarding the location of the hotel that was shown in the video near the time that the user rotated the cube 30. Alternatively, the user may rotate the cube 30 from left-to-right, so that side 64 faces the user. Side 64 may contain information regarding one or more characters shown in the video. The user may rotate the cube 30 from right-to-left so that the side facing the user displays information regarding similar videos. The user may rotate the cube 30 so that the side opposite side 62 faces the user, which may display vendors for products or services displayed, referenced, or advertised in the video.

The 3-D object 30 may be used to view information that has a recommended order of viewing. Portions of the ordered information may be placed on the sides of the 3-D object 30 so that it can be viewed in order as the 3-D object 30 is rotated. The user may view the information in the recommended order, in reverse order, or in any order. The 3-D object 30 may be rotated from right-to-left to view the information in the recommended order, from left-to-right to view the information in the reverse order, or in another manner to view the information out of order. For example, with reference to FIG. 5, sides 52, 54, 58 and the side parallel to side 54 (not pictured) may each contain part of a review of a product. A user viewing side 52 may rotate the cube 30 from right-to-left to view the next portion of the review, or may rotate the cube 30 from left-to-right to return to a previous portion of the review on side 54. Alternatively, the 3-D object may be rotated from left-to-right to view the information in the recommended order, from right-to-left to view the information in the reverse order, or in another manner to view the information out of order.

Similarly, the 3-D object 30 may be rotated from bottom-to-top to view the information in the recommended order, from top-to-bottom to view the information in the reverse order, or in another manner to view the information out of order. For example, with reference to FIG. 6, sides 62, 66, 68 and the side parallel to side 66 (not pictured) may each contain part of a review of a product. A user viewing side 62 may rotate the cube 30 from bottom-to-top to view the next portion of the review, or may rotate the cube 30 from top-to-bottom to return to a previous portion of the review on side 66. Alternatively, the 3-D object may be rotated from top-to-bottom to view the information in the recommended order, from bottom-to-top to view the information in the reverse order, or in another manner to view the information out of order.

In some embodiments, the category or type of information displayed may be changed by rotating the 3-D object 30 in a manner other than the manner that displays the information in the recommended or reverse orders. For example, with reference again to FIG. 6, the recommended order may be viewed by rotating from bottom-to-top while the reverse order may be viewed by rotating from top-to-bottom. The type of information displayed on the front-facing side of the cube 30 may be changed by rotating from left-to-right or right-to-left. For instance, if a review of a television is being displayed on front-facing side 62 (and sides 66 and 68), then rotating the cube 30 from left-to-right would display side 64 as the front-facing side. Side 64 may contain pricing information about the television reviewed on side 62.

The 3-D object 30 may be used to execute one or more commands in response to input. Input related to the rotation of the 3-D object 30 may have the effect of executing one or more commands Rotating in one direction may cause one command (or set of commands) to be executed, while rotating in another direction may cause a different command (or a different set of commands) to be executed. For example, with regard to FIG. 5, a user viewing side 52 may rotate the cube 30 from right-to-left. This may have the effect of sharing the information displayed on side 52 with the user's friends on a social networking site.

The computer-executable instructions that encode the process of displaying a 3-D object 30 may be written in any programming language that supports an implementation of the present invention. For example, HTML5 (the fifth revision of the Hypertext Markup Language) may be used to encode instructions for rendering what appears to be a 3-D object (that rotates or otherwise changes) in two dimensions. The styles of the 3-D object 30 may be encoded in CSS (Cascading Style Sheets) stylesheets. Input events, such as keyboard key presses, mouse input, touch events on a touch-sensitive device, or motion events from a motion sensing device may be encoded using JavaScript.

Browsers supporting HTML5 may be used to execute these scripts and markup, and then send appropriate display data to a display, so that the display will show the 3-D object 30. For example, <div> markup tags may be used in HTML5 to create the sides of the 3-D object 30:

<div id=“cube”>
<section id=“contentBody” section=“mncol”>
<article>
<div class=“post list first”>
<header section=“title”>
<h1><a href=“newstory/”>News Title</a></h1>
<div class=“postByline”>
<a rel=“author” href=“/profile/ ”><img class=“mugshot” src=“image.png” height=“60”
width=“60” /></a> <div id=“nameAndTime”> <span class=“author”> By: <a
rel=“author” href=“/profile/ ”>Name </a> </span>
<time class=“datestamp”> July 22, 2011 7:30 AM EDT </time>
<div class=“entryType”>Post</div>
</div>
<ul class=“contentTools”>
<li><a class=“linkIcon_print”>Print</a></li> <li><a class=“linkIcon_email”>E-
mail</a></li> </ul>
</div>
<div class=“commentAndSocialIcons”>
<div class=“socialBadges_socialBar” section=“shareByline”>
<span class=“shareButton”><a class=“linkIcon_share”>Share</a></span>
</div>
</div>
</header>
<div class=“postBody txtWrap” section=“txt” >
<p>Article Text
</p><p>
<a href=“link_to_full_post/” class=“readMore”>&#0133; Read full post &
comments</a></p> </div><footer>
<div section=“tags” class=“tagsWrap”> <div class=“postLinks”> <dl>
<dt><b>Topics:</b></dt> <dd> <a href=“music link”>Music</a>, </dd> <dd> <a
href=“file_link”>File Sharing</a> </dd> </dl> <dl> <dt><b>Tags:</b></dt> <dd> <a
href=“keyword_link”>Keyword</a>, </dd> <dd> <a href=“additional_link”>Link</a>,
</dd> <dd> <a href=“another_link”>Another Link</a> </dd> </dl> <div id=“shareTags”
section=“shareTags”> <dl> <dt><b>Share:</b></dt> <dd><a class=“linkIcon a”
href=“social_network_link_a.html” target=“_blank” >Social Networking</a></dd>
<dd><a class=“linkIcon b” href=“ social_network_link_b.html” target=“_blank” >Link
B</a></dd> <dd><a class=“linkIcon c” href=“link_c.html”>Link C</a></dd> <dd><a
class=“linkIcon d” href=“link_d.html”>Link D</a></dd> <dd><a class=“linkIcon e”
href=“link_e.html”>Link E</a></dd> <dd><a target=“_blank” class=“linkIcon f”
title=“Link f” href=“link_f.html”>Link F</a></dd> <dd><a class=“linkIcon g”
href=“link_g.html” target=“_blank” >Link G</a></dd> </dl>
</div></div></div></div>
</article>

Input events that direct rotation or other movement of the 3-D object 30 may be handled using JavaScript, such as the following, which accepts touch input from a touch screen, such as that on a smartphone:

```
<script>
var mobileTouchX = null;
var mobileTouchY = null;
document.addEventListener(‘touchstart’, function(event) {
mobileTouchX = event.touches[0].pageX;
mobileTouchY = event.touches[0].pageY;
});
document.addEventListener(‘touchmove’, function(event) {
      var direction = (mobileTouchX − event.touches[0].pageX) >
      0 ? ‘right’ : ‘left’
      var direction2 = (mobileTouchY − event.touches[0].pageY) >
      0 ? ‘top’ : ‘bottom’
      var xAngle = 0, yAngle = 0;
      switch(direction)
            {
                        case ‘left’: // left
                                    yAngle −= 90;
                                    break;
                        case ‘right’: // right
                                    yAngle += 90;
                                    break;
            };
      switch(direction2)
            {
            case ‘top’: // up
                                          xAngle += 90;
                                          break;
            case ‘bottom’: // down
                                    xAngle −= 90;
                                    break;
            };
            $(‘contentBody’).style.webkitTransform =
“rotateX(“+xAngle+”deg) rotateY(“+yAngle+”deg)”;
});
</script>
```

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein.

The above-described embodiments can be implemented using hardware, software or a combination thereof. When implemented in software, the software code can be executed on any suitable processor or collection of processors, whether provided in a single computer system (“computer”) or distributed among multiple computers.

Further, it should be appreciated that a computer may be embodied in any of a number of forms, such as a rack-mounted computer, a desktop computer, a laptop computer, a server computer, a cloud-based computing environment, a tablet computer, a game console, etc. Additionally, a computer may be embedded in a device not generally regarded as a computer but with suitable processing capabilities, including a Personal Digital Assistant (PDA), a smart phone or any other suitable portable or fixed electronic device.

Various embodiments may include hardware devices, as well as program products comprising computer-readable, non-transient storage media for carrying or having data or data structures stored thereon for carrying out processes as described herein. Such non-transient media may be any available media that can be accessed by a general-purpose or special-purpose computer or server. By way of example, such non-transient storage media may comprise random-access memory (RAM), read-only memory (ROM), erasable programmable read-only memory (EPROM), electrically erasable programmable read-only memory (EEPROM), field programmable gate array (FPGA), flash memory, compact disk, or other optical disk storage, magnetic disk storage or other magnetic storage devices, or any other medium which can be used to carry or store desired program code in the form of computer-executable instructions or data structures and which can be accessed by a general-purpose or special-purpose computer. Combinations of the above may also be included within the scope of non-transient media. Volatile computer memory, non-volatile computer memory, and combinations of volatile and non-volatile computer memory may also be included within the scope of non-transient storage media. Computer-executable instructions may comprise, for example, instructions and data that cause a general-purpose computer, special-purpose computer, or special-purpose processing device to perform a certain function or group of functions.

In addition to a system, various embodiments are described in the general context of methods and/or processes, which may be implemented in some embodiments by a program product including computer-executable instructions, such as program code. These instructions may be executed by computers in networked environments. The terms “method” and “process” are synonymous unless otherwise noted. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

In some embodiments, the method(s) and/or system(s) discussed throughout may be operated in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet. Those skilled in the art will appreciate that such network computing environments may encompass many types of computer system configurations, including personal computers, hand-held devices, multi-processor systems, microprocessor-based or programmable consumer electronics, network PCs, minicomputers, mainframe computers, and the like.

In some embodiments, the method(s) and/or system(s) discussed throughout may be operated in distributed computing environments in which tasks are performed by local and remote processing devices that may be linked (such as by hardwired links, wireless links, or by a combination of hardwired or wireless links) through a communications network. In a distributed computing environment, according to some embodiments, program modules may be located in both local and remote memory storage devices. Data may be stored either in repositories and synchronized with a central warehouse optimized for queries and/or for reporting, or stored centrally in a database (e.g., dual use database) and/or the like.

The various methods or processes outlined herein may be coded and executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. The computer-executable code may include code from any suitable computer programming or scripting language or may be compiled from any suitable computer-programming language, such as, but not limited to, ActionScript, C, C++, C#, Go, HTML, Java, JavaScript, JavaScript Flash, Objective-C, Perl, PHP, Python, Visual Basic, and XML.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the invention discussed above. The computer-readable medium or media can be transportable, such that the program or programs stored thereon can be loaded onto one or more different computers or other processors to implement various aspects of the present invention as discussed above. The recitation of a module, logic, unit, or circuit configured to perform a function includes discrete electronic and/or programmed microprocessor portions configured to carry out the functions. For example, different modules or unit that perform functions may be embodied as portions of memory and/or a microprocessor programmed to perform the functions.

Additionally, it should be appreciated that according to one aspect, one or more computer programs that, when executed, perform methods of the present invention, need not reside on a single computer or processor, but may be distributed in a modular fashion amongst a number of different computers or processors to implement various aspects of the present invention.

The indefinite articles “a” and “an,” as used herein in the specification and in the claims, unless clearly indicated to the contrary, should be understood to mean “at least one.”

While specific embodiments have been disclosed, the various embodiments are not to be considered limiting. One of ordinary skill in the art will understand that variations and modifications flow from the teachings provided herein.

What is claimed is:

1. A method for displaying information, the method comprising:
displaying, on a display, a representation of at least one 3-D object, wherein information is displayed on at least one side of the at least one 3-D object;
wherein information displayed on a first side of the at least one 3-D object is related to information displayed on a second side of the at least one 3-D object.

2. The method of claim 1, further comprising:
receiving, at a processor, input related to changing an appearance of an orientation of the at least one 3-D object; and
displaying, on the display, a change in the appearance of an orientation of the at least one 3-D object, based on the input.

3. The method of claim 2, wherein the change in the appearance of the orientation of the at least one 3-D object is that the at least one 3-D object appears to rotate, rotate at a different speed, rotate in a different direction, or stop rotating.

4. The method of claim 1, wherein the information displayed on the first side is not displayed at the same time as information displayed on the second side.

5. The method of claim 1, wherein the information displayed on the first side is related to information displayed on all other sides of the at least one 3-D object.

6. The method of claim 1, wherein the information is related to products, news, blogs, sports, or social media.

7. The method of claim 1, wherein the information on one or more sides of the at least one 3-D object changes dynamically.

8. The method of claim 1, wherein a video is displayed on the first side and information related to the content of the video is displayed on the second side.

9. The method of claim 1, wherein the information on the first side and the second side has an order, such that the information displayed on the first side precedes the information on the second side in the order.

10. The method of claim 9, wherein the type of information on the first side and the second side is different from the type of information on a third side of the at least one 3-D object.

11. A computer system for displaying information, comprising:
memory hardware storing program instructions, and one or more processors in data communication with the memory hardware and configured to execute the program instructions, and upon execution the program instructions cause the one or more processors to perform operations comprising:
providing display data representing at least one 3-D object, wherein information is displayed on at least one side of the at least one 3-D object;
wherein information displayed on a first side of the at least one 3-D object is related to information displayed on a second side of the at least one 3-D object.

12. The computer system of claim 11, wherein the memory hardware is located on one or more servers that transfers the program instructions to a client computing device for execution.

13. The computer system of claim 11, wherein the instructions when processed by a processing circuit further perform:
receiving, at a processor, input related to changing an appearance of an orientation of the at least one 3-D object; and
displaying, on the display, a change in the appearance of an orientation of the at least one 3-D object, based on the input.

14. The computer system of claim 13, wherein the change in the appearance of the orientation of the at least one 3-D object is that the at least one 3-D object appears to rotate, rotate at a different speed, rotate in a different direction, or stop rotating.

15. The computer system of claim 11, wherein the information displayed on the first side is not displayed at the same time as information displayed on the second side.

16. The computer system of claim 11, wherein the information displayed on the first side is related to information displayed on all other sides of the at least one 3-D object.

17. The computer system of claim 11, wherein the information is related to products, news, blogs, sports, or social media.

18. The computer system of claim 11, wherein the information on one or more sides of the at least one 3-D object changes dynamically.

19. The computer system of claim 11, wherein a video is displayed on the first side and information related to the content of the video is displayed on the second side.

20. The computer system of claim 11, wherein the information on the first side and the second side has an order, such that the information displayed on the first side precedes the information on the second side in the order.

21. The computer system of claim 20, wherein the type of information on the first side and the second side is different from the type of information on a third side of the at least one 3-D object.

22. A tangible computer-readable medium having instructions encoded thereon, wherein the instructions when processed by a processing circuit perform the following:
displaying, on a display, a representation of at least one 3-D object, wherein information is displayed on at least one side of the at least one 3-D object;
wherein information displayed on a first side of the at least one 3-D object is related to information displayed on a second side of the at least one 3-D object.

23. The tangible computer-readable medium of claim 22, wherein the instructions when processed by a processing circuit further perform:
receiving, at a processor, input related to changing an appearance of an orientation of the at least one 3-D object; and
displaying, on the display, a change in the appearance of an orientation of the at least one 3-D object, based on the input.

24. The tangible computer-readable medium of claim 22, wherein the information displayed on the first side is not displayed at the same time as information displayed on the second side.

25. The tangible computer-readable medium of claim 22, wherein the information is related to products, news, blogs, sports, or social media.

26. The tangible computer-readable medium of claim 22, wherein the information on one or more sides of the at least one 3-D object changes dynamically.

27. The tangible computer-readable medium of claim 22, wherein a video is displayed on the first side and information related to the content of the video is displayed on the second side.

28. The tangible computer-readable medium of claim 22, wherein the information on the first side and the second side has an order, such that the information displayed on the first side precedes the information on the second side in the order.

29. The tangible computer-readable medium of claim 28, wherein the type of information on the first side and the second side is different from the type of information on a third side of the at least one 3-D object.
